(19) United States
(12) Patent Application Publication
(10) Pub. No.: US 2011/0164762 A1
(43) Pub. Date: Jul. 7, 2011

(54) AUDIO FEEDBACK SUPPRESSION DEVICE AND METHOD FOR SUPPRESSING AUDIO FEEDBACK

(75) Inventors: Ryo Oouchi, Hamamatsu-shi (JP); Kosuke Saito, Hamamatsu-shi (JP)

(73) Assignee: YAMAHA CORPORATION, Hamamatsu-shi, Shizuoka (JP)

(21) Appl. No.: 12/997,825

(22) PCT Filed: Jun. 18, 2009
(86) PCT No.: PCT/JP2009/061122

§ 371 Date: Dec. 13, 2010

(30) Foreign Application Priority Data
Jun. 18, 2008 (JP) 2008-159495

(51) Int. Cl. H04B 15/00

(52) U.S. Cl. 381/93

(57) ABSTRACT

An audio feedback suppression device is provided that outputs a sound while changing a phase so as not to generate audio feedback without performing a relatively complicated process. A phase control section 2 generates a phase adjustment value θ gradually varying with the lapse of time and gives the value θ to an adjustment signal generation section 121 of a phase shifter 1. Phase adjustors 111 and 112 of the phase shifter 1 output two first stage adjusted signals having phases which are shifted from each other by π/2 in accordance with a shifter input signal. An adjusting signal generation section 121 generates a cosine value cos(θ) and a sine value sin(θ) of a phase adjustment value 0 and gives the values to respective multipliers 123A and 123B. The multiplier 123A multiplies one of the first stage phase adjusted signals to the cosine value cos(θ) and the multiplier 123B multiplies the other first stage phase adjusted signal to the sine value sin(θ). An adder 13 adds the multiplied signals together so as to output a shifter output signal having a phase gradually varying with respect to a shifter input signal.

### TECHNICAL FIELD

The present invention relates to an audio feedback suppression device and a method for suppressing audio feedback that can suppress beforehand audio feedback which may occur when an output audio signal is fed back as an input audio signal.

### BACKGROUND ART

In a loudspeaker device or the like, a voice of a user is picked up by a microphone and a pick-up audio signal is amplified so as to be output from a speaker. At that time, audio feedback may be generated by a feedback loop that is formed in such a manner that the output sound is picked up by the microphone again. Since audio feedback sound is normally uncomfortable to a user or the like, various kinds of audio feedback cancellers (audio feedback suppression devices) have been provided heretofore. For example, in a patent document 1, shifting of four different phases (0°, 45°, 90° and)135° is applied to an input audio signal. By using the audio signals with shifted phases, a plurality of audio signals for output having different phases are generated depending on the situation and are switchably output by using a cross fader or the like.

### PRIOR ART DOCUMENTS

### Patent Documents

Patent Document 1: JP-A-2006-261965

### SUMMARY OF THE INVENTION

### Problems that the Invention is to Solve

In such a prior art audio feedback canceller, various complicated processes are performed so as to obtain an audio signal for output. In the above patent document 1, for example, (1) four audio signals having different phases are generated with respect to one input audio signal, and (2) by combining the audio signals, a plurality of audio signals for output having different phases are generated. Further, (3) these plurality of audio signals for output are switchably output. At that time, (4) a cross fade process is performed so as to hold the output audio signal at a constant level.

Thus, heretofore, in order to obtain an output audio signal in which the level is constant and the phase is changed, a relatively complicated process requiring a resource such as simultaneous production of many audio signals having different phases, cross fading or the like, has had to be performed.

A purpose of the invention is to achieve an audio feedback suppression device that outputs a sound while changing a phase of a sound signal so as not to generate audio feedback without performing a relatively complicated process, and to achieve a method for suppressing audio feedback.

### Means for Solving the Problems

An audio feedback suppression device according to the invention includes an adjusting phase value control section, a first stage phase adjustment section, a second stage phase adjustment section, and an output stage adder.

The first stage phase adjustment section adjusts a phase of an input audio signal so as to output two first stage phase adjusted signals having phases which are shifted from each other by π/2 while synchronizing the two first stage phase adjusted signals with each other. The adjusting phase value control section outputs a second adjusting phase for further shifting the phase of the first stage phase adjusted signals while changing the second adjusting phase with the lapse of time. The second stage phase adjustment section calculates a first multiplication coefficient which is one of a sine value and a cosine value of the second adjusting phase and a second multiplication coefficient which is the other of the values. The second stage phase adjustment section multiplies the first multiplication coefficient to one of the two first stage phase adjusted signals to output a first multiplied signal. In addition, the second stage phase adjustment section multiplies the second multiplication coefficient to the other of the first stage phase adjusted signals to output a second multiplied signal. The output stage adder adds the first multiplied signal and the second multiplied signal together to generate an output audio signal.

With the above configuration, first, the two first stage phase adjusted signals having phases which are shifted from each other by π/2, are generated from the input audio signal. The two first stage phase adjusted signals are respectively multiplied with the first multiplication coefficient and the second multiplication coefficient having phases which vary while constantly maintaining a phase difference of π/2. To be specific, one of the two first stage phase adjusted signals is multiplied with the first multiplication coefficient to generate the first multiplied signal and the other of the first stage phase adjusted signals is multiplied with the second multiplication coefficient to generate the second multiplied signal. The first multiplied signal and the second multiplied signal are added together. To be specific, the addition corresponds to the following expression with the proviso that the input audio signal and one of the first stage phase adjusted signals are represented by cos φ, the other of the first stage phase adjusted signals is represented by cos (φ−π/2), the first multiplication coefficient is represented by cos θ and the second multiplication coefficient is represented by sin θ.

cosφ·cosθ+cos (φ−π/2)·sinθ Expression 1

It means that this expression is replaced with a monadic expression of cos (φ−θ) by an addition theorem of the phases φ and θ. That is, an output signal having the phase θ which is different with respect to the input audio signal can be obtained. The phase θ is changed with the lapse of time by an adjustment phase value control section so that an output audio signal of which the amplitude does not vary but only the phase varies with the lapse of time with respect to the input audio signal, is obtained.

In addition, preferably, the first stage phase adjustment section includes a π/2 phase shift circuit and a delay circuit.

With the above configuration, since it is not necessary to provide two phase shift circuits but only one phase shift circuit is enough, it is possible to simplify an operating process and to save the resource.

Moreover, preferably, the adjusting phase value control section performs a phase control process in such a manner that a time period of changing the second adjusting phase with the lapse of time and a time period of not changing the second adjusting phase are sequentially repeated.

With the above configuration, when the phase is changed as described above, a frequency characteristic of an output audio signal is changed in response to a speed of the change in the phase. However, by providing the time period of not changing the phase, it is possible to reduce feeling of discomfort in hearing due to a change in the frequency characteristic of the output audio signal.

Furthermore, preferably, the audio feedback suppression device according to the invention includes a plurality of phase adjustment sections each having the first stage phase adjustment section, the second stage phase adjustment section and the output stage adder. The audio feedback suppression device further includes a band division section that divides an input audio signal into different frequency bands and outputs the divided signals to the respective first stage phase adjustment sections of the plurality of phase adjustment sections, and a composite output section that adds output audio signals of the phase adjustment sections together so as to generate a composite output signal.

With the above configuration, a change in the phase is divisionally performed by each of the frequency bands. Accordingly, it is possible to set the change in the phase suitable for each of the frequency bands.

A method for suppressing audio feedback according to the invention includes a process of adjusting a phase of an input audio signal and outputting two first stage phase adjusted signals having phases which are shifted from each other by π/2 while synchronizing the two first stage phase adjusted signals with each other, a process of outputting a second adjustment phase while changing the second adjustment phase with the lapse of time, a process of calculating a first multiplication coefficient which is one of a sine value and a cosine value of the second adjusting phase and a second multiplication coefficient which is the other of the values, multiplying the first multiplication coefficient to one of the first stage phase adjusted signals to output a first multiplied signal and multiplying the second multiplication coefficient to the other of the first stage phase adjusted signals to output a second multiplied signal, and a process of adding the first multiplied signal and the second multiplied signal together to generate an output audio signal.

Preferably, in the second adjusting phase, a time period of changing the second adjusting phase with the lapse of time and a time period of not changing it are sequentially repeated.

Preferably, the method for suppressing audio feedback further includes a process of dividing the input audio signal into different frequency bands, a process of adjusting the band-divided input audio signals in the respective processes to generate a plurality of output audio signals, and a process of adding the output signals together to generate a composite output signal.

### Advantage of the Invention

In accordance with the invention, it is possible to generate an output audio signal of which the amplitude has an equal level of that of an input audio signal and the phase varies with respect to the input audio signal and to prevent audio feedback in relatively simple structure and process.

### BRIEF DESCRIPTION OF THE DRAWINGS

FIG. 1 is a block diagram showing a structure of a loudspeaker having an audio feedback suppression device according to a first embodiment of the invention.

FIG. 2 is a block diagram showing a phase shifter shown in FIG. 1.

FIG. 3 is a graph showing an example of a phase shift pattern.

FIG. 4 is a block diagram showing a loudspeaker having an audio feedback suppression device according to a second embodiment of the invention.

### MODE FOR CARRYING OUT THE INVENTION

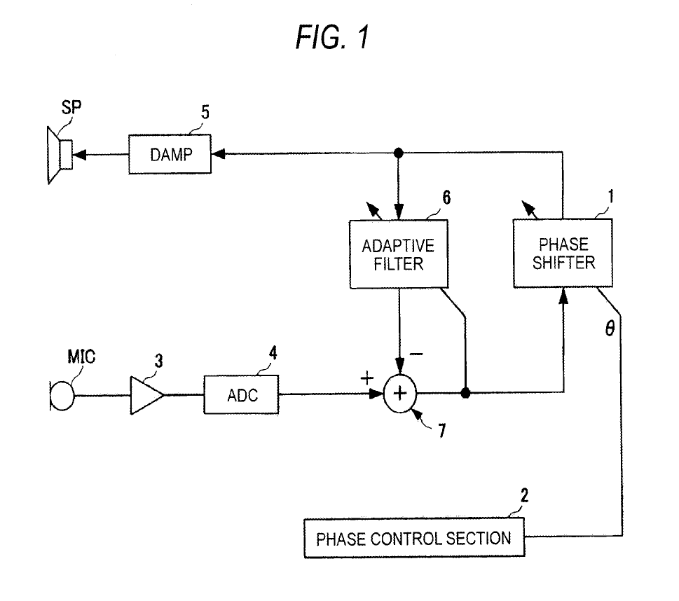

An audio feedback suppression device according to a first embodiment of the invention will be described with reference to the accompanying drawings. FIG. 1 is a block diagram showing a structure of a loudspeaker having the audio feedback suppression device of the embodiment.

The loudspeaker includes a microphone MIC, a speaker SP, a phase shifter 1, a phase control section 2, an amplifier 3, an AD converter (ADC) 4, a digital amplifier (DAMP) 5, an adaptive filter 6, and an addar 7. Here, a part formed of the phase shifter 1 and the phase control section 2 corresponds to the audio feedback suppression device of the invention.

The microphone MIC picks up a voice or the like of a user so as to transfer it to the amplifier 3, and the amplifier 3 amplifies the picked-up audio signal so as to transfer it to the ADC 4. The ADC 4 converts the analogue picked-up audio signal into a digital format so as to output it to the adder 7. The adder 7 subtracts a pseudo feedback audio signal given by the adaptive filter 6 described later from the picked-up audio signal so as to output it to the phase shifter 1.

The phase shifter 1 applies a phase adjustment to the input audio signal of which the feedback audio signal is removed (hereinafter, simply referred to as “shifter input audio signal”) on the basis of a shift phase value θ given by the phase control section 2. A shifter output signal output from the phase shifter 1 is given to the DAMP 5 and the adaptive filter 6.

The adaptive filter 6 generates the above described pseudo feedback audio signal based on the shifter output signal by using a filter coefficient estimated in accordance with the shifter input signal which is the output signal of the adder 7, and the adaptive filter 6 gives it to the adder 7.

The DAMP 5 amplifies the phase adjusted signal and gives the amplified signal to the speaker SP, and the speaker SP outputs the amplified signal as a sound.

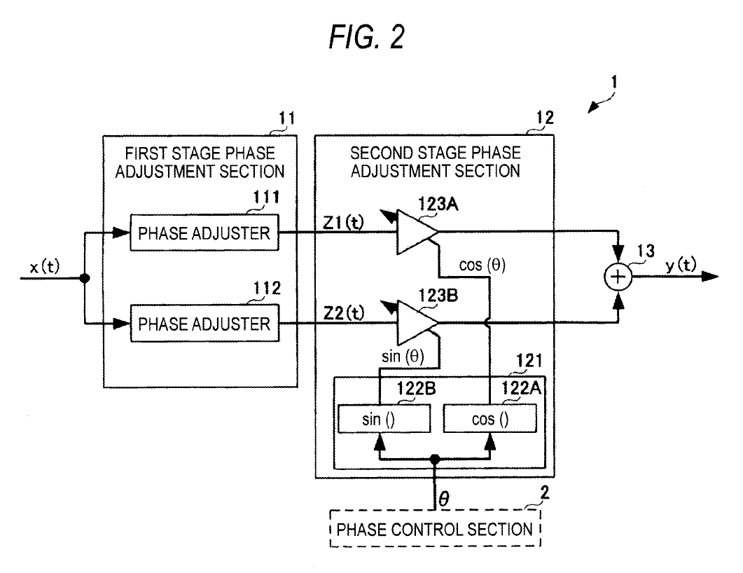

Next, a specific structure of the phase shifter 1 is described with reference to FIG. 2. FIG. 2 is a block diagram showing the structure of the phase shifter 1 shown in FIG. 1.

The phase shifter 1 includes a first stage phase adjustment section 11, a second stage phase adjustment section 12 and an adder 13. In the following description, an input of the phase shifter is represented by a signal x(t). The first stage phase adjustment section 11 includes phase adjusters 111 and 112, and the shifter input signal x(t) is distributed to be respectively input to the phase adjusters 111 and 112. The shifter input signal x(t) corresponds to “input audio signal” of the invention. The phase adjuster 111 is formed of a simple delay circuit and performs a delay operation with respect to the shifter input signal x(t) corresponding to a delay amount occurring due to the phase adjustment by the phase adjuster 112. The phase adjuster 112 is made of a so-called Hilbert filter or the like and performs the phase adjustment under a condition that phase adjustment amounts are made to be the same over all of the bands of the input audio signal x(t). The phase adjuster 112 corresponds to the “π/2 phase shift circuit” of the invention. Accordingly, first stage phase adjusted signals Z1(t) and Z2(t) output from the first stage phase adjustment section 11 are made to have the same amplitude level and to constantly have a phase difference of π/2 [rad].

The second stage phase adjustment section 12 includes an adjustment signal generation section 121, and multipliers 123A and 123B. The adjustment signal generation section 121 has a cosine value generation section 122A and a sine value generation section 1228.

The cosine value generation section 122A generates a cosine value cos(θ) in accordance with a phase adjustment value θ given by the phase control section 2 so as to output it to the multiplier 123A. Here, the cosine value cos(θ) corresponds to the “first multiplication coefficient” of the invention.

The sine value generation section 122B generates a sine value sin(θ) in accordance with a phase adjustment value θ given by the phase control section 2 so as to output it to the multiplier 123B. Here, the sine value sin(θ) corresponds to the “second multiplication coefficient” of the invention.

Meanwhile, the phase adjustment value θ is changed with the lapse of time (a changing time period and a constant time period can be repeated), and a setting pattern is described later.

The multiplier 123A multiplies the cosine value cos(θ) to the first stage phase adjusted signal Z1(t) so as to output a first multiplied signal Z1(t)·cos(θ). The multiplier 123B multiplies the sine value sin(θ) to the second stage phase adjusted signal Z2(t) so as to output a second multiplied signal Z2(t)·sin(θ).

The adder 13 adds the first multiplied signal Z1(t)·cos(θ) and the second multiplied signal Z2(t)·sin(θ) together so as to generate and output a shifter output signal y(t). The shifter output signal y(t) corresponds to the “output audio signal” of the invention.

As in the above, in a case where the phase shifter 1 performs a phase adjustment operation, the shifter input signal x(t) and the shifter output signal y(t) have a following relationship. Meanwhile, these signals are audio signals each having a plurality of frequency components included in a frequency band that can be picked up by a microphone. However, in the descriptions below, in order to ease the explanation, the shifter input signal x(t) is assumed to be a cosine wave of a specific frequency f of which the amplitude is normalized (“1”).

That is, the shifter input signal x(t) is represented by the following expression (Expression 2).

x(t)=cos(2πft) Expression 2

The first stage phase adjusted signal Z1(t) output from the phase adjuster 111 is represented by Expression 3 with the proviso that a delay in the phase adjuster 111 is represented by τ. Here, that is, as follows.

Z1(t)=cos{2πf(t−τ)} Expression 3

On the other hand, since the first stage phase adjusted signal Z2(t) output from the phase adjuster 112 is shifted by π/2 with respect to the shifter input audio signal x(t), it is represented by Expression 4.

Z2(t)=cos{2πf(t−τ)−π/2} Expression 4

Note that “τ” is a delay due to an operation of a phase shift by the phase adjuster 112. Hereinafter, “(t−τ)” is replaced with “t”. Accordingly, the first multiplied signal Z1(t)·cos(θ) output from the multiplier 123A of the second stage phase adjustment section 12 is represented by Expression 5.

Z1(t)·cos(θ)=cos(2πft)·cos(θ) Expression 5

On the other hand, the second multiplied signal Z2(t)·sin(θ) output from the multiplier 123B of the second stage phase adjustment section 12 is represented by Expression 6.

Z2(t)·sin(θ)=cos(2πft−π/2)·sin(θ) Expression 6

Consequently, the shifter output signal y(t) output from the adder 13 is represented by Expression 7.

y(t)=Z1(t)·cos(θ)+Z2(t)·sin(θ)=cos(2πft)·cos(θ)+cos(2πft−π/2)·sin(θ) Expression 7

Here, when a conversion relationship between sin(θ) and cos(θ) and an addition theorem are used, the shifter output signal y(t) formed of the Expression 7 is represented by the following expression.

y(t)=cos(θ)·cos(2πft)+sin(θ)·sin(2πft)=cos(2πft−θ) Expression 8

Thus, the shifter output signal y(t) becomes a signal in which the amplitude level thereof does not vary with respect to the shifter input signal x(t) and the phase shift according to the phase adjustment value θ is applied. Since the phase adjustment value θ is changed, the shifter output signal y(t) becomes a signal having a phase shift amount corresponding to the phase adjustment value θ that is changed with respect to the shifter input signal x(t).

By changing the phase adjustment value θ as in the above, a frequency that tends to cause audio feedback determined by a feedback system, i.e., a use environment and a frequency characteristic of a sound to be a feedback target under the use environment, varies from hour to hour. Accordingly, growth of a specific frequency component due to a positive feedback is prevented so that it is possible to suppress occurrence of audio feedback.

In addition, by making one of the phase adjusters 111 and 112 of the first stage phase adjustment section 11 to be a simple delay circuit, it is not necessary to form both of the phase adjusters 111 and 112 by filters. Accordingly, it is possible to achieve the generation of the first stage phase adjusted signals Z1(t) and Z2(t) having the phase difference of π/2 from each other by a simple circuit structure and a simple process.

Next, a specific setting method of the phase adjustment value θ is described below.

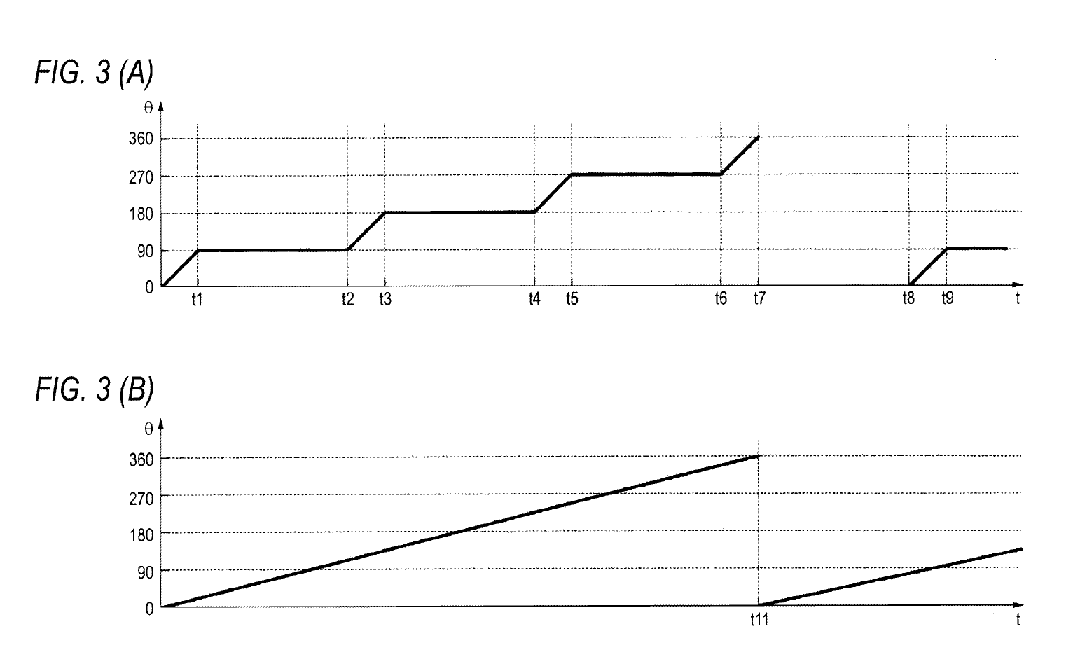

The phase control section 2 determines the phase adjustment value θ on the basis of the phase shift patterns set in advance as shown in FIGS. 3(A) and 3(B) at every predetermined timing such as, for example, sampling timing or the like, and gives it to the adjustment signal generation section 121. FIGS. 3(A) and 3(B) show examples of phase shift patterns, (A) shows a pattern in which a time period of changing the phase and a time period of not changing the phase are repeated, and (B) shows a pattern in which the phase is constantly changed.

To be specific, in a case of the pattern of FIG. 3(A), by making the phase adjustment value θ at an initial time (t=0) zero, the phase adjustment value θ is continuously changed from 0 to π/2 in a positive phase direction with the lapse of time until a timing corresponding to a clock time t1. The time length of the change time period is, for example, 50 msec., or preferably slightly longer than the time length. After that, in a predetermined period of time (t2−t1), the phase adjustment value θ is made constant at π/2.

When it becomes a clock time t2, the phase adjustment value θ is continuously changed from π/2 to π with the lapse of time until a timing corresponding to a clock time t3. The time length of the change time period is set to be the same as the case where the phase adjustment value θ is continuously changed from 0 to π/2. After that, in a predetermined period of time (t4−t3), the phase adjustment value θ is made constant at π.

When it becomes a clock time t4, the phase adjustment value θ is continuously changed from π to 3π/2 with the lapse of time until a timing corresponding to a clock time t5. The time length of the change time period is set to be the same as the case where the phase adjustment value θ is continuously changed from 0 to π/2. After that, in a predetermined period of time (t6−t5), the phase adjustment value θ is made constant at 3π/2.

When it becomes a clock time t6, the phase adjustment value θ is continuously changed from 3π/2 to 2π(=0) with the lapse of time until a timing corresponding to a clock time t7. The time length of the change time period is set to be the same as the case where the phase adjustment value θ is continuously changed from 0 to π/2. After that, in a predetermined period of time (t8−t7), the phase adjustment value θ is made constant at 2π(=0).

Afterward, the phase control section 2 performs the above described controlling of repeating a time period of changing the phase adjustment value θ and a time period of maintaining the value constant.

By using the pattern as shown in FIG. 3(A), it is possible to absorb influence to hearing sense of a user due to a change in the frequency characteristic δf=δθ/δt which may occur by a change in the phase. Meanwhile, an adequate value of the length of the constant time period differs depending on the use environment. However, from a qualitative point of view, the constant time period may be of any time length as long as audio feedback does not occur during the constant time period.

On the other hand, in a case of the pattern of FIG. 3(B), by making the phase adjustment value θ at an initial time (t32 0) zero, the phase adjustment value θ is continuously changed from 0 to 2π in the positive phase direction with the lapse of time until a predetermined clock time t11. The phase control section 2 performs the above described controlling of repeating the changing of the phase adjustment value θ.

By using the pattern shown in FIG. 3(B), the constant time period is eliminated as shown in FIG. 3(A), so that it is possible to prevent audio feedback caused by the constant time period from occurring.

While the example is described in which the phase is shifted by π/2 in the change time period having the time length of 50 msec. in the pattern shown in FIG. 3(A), the time length can be made longer or shorter in some cases. In a case where the time length is made longer, that is, a rate of changing the phase is reduced, it is possible to reduce a shift amount of a frequency in the change time period. In this case, when the change rate of the phase is excessively reduced, audio feedback may possibly occur even in the change time period. Therefore, it is preferable that the time length of the change time period and the shift amount of the phase to be changed in the change time period are set in consideration of a problem of hearing sense due to the shift amount of the frequency and a problem of occurrence of audio feedback. Meanwhile, the way of changing the adjustment phase value is not limited to the above embodiment. It is enough that a change in sound quality is small and an effect of suppressing audio feedback is obtained.

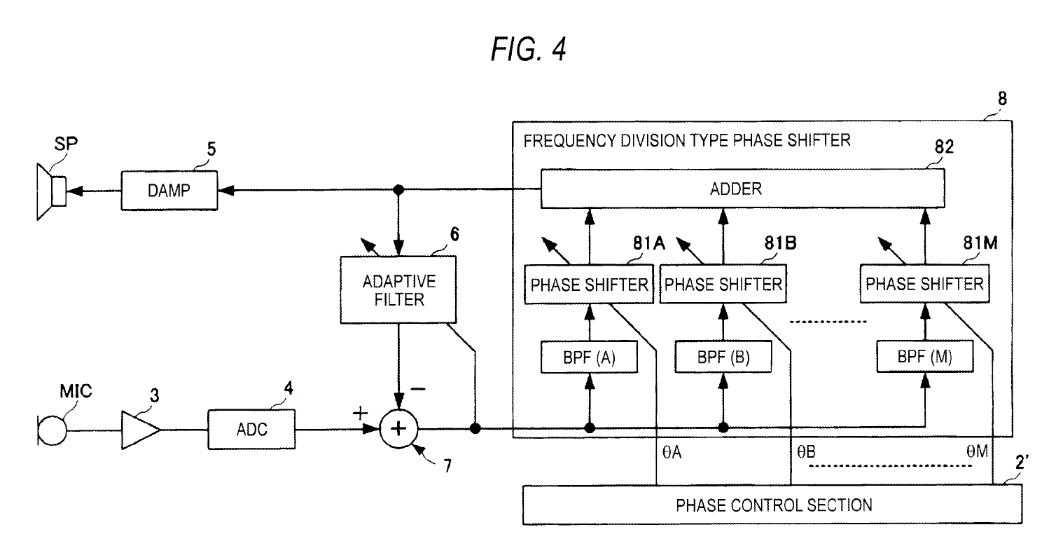

Next, an audio feedback suppression device according to a second embodiment is described below with reference to a drawing. FIG. 4 is a block diagram showing a structure of a loudspeaker having the audio feedback suppression device of the embodiment.

The audio feedback suppression device shown in FIG. 4 of the embodiment is formed by adding a concept of frequency dividing to the audio feedback suppression device of the first embodiment shown in FIGS. 1 and 2. Therefore, parts the same as those in the first embodiment of the loudspeaker are denoted by the same numerals, and descriptions thereof are omitted.

The audio feedback suppression device of the embodiment includes a frequency division type phase shifter 8 and a phase control section 2′. The frequency division type phase shifter 8 has band pass filters BPF(A) to BPF(M), phase shifters 81A to 81M and an adder 82. While the embodiment described here has the band pass filters and the phase shifters each of which the number is thirteen, i.e., A to M, the number can be set depending on a specification of the device for its convenience.

The band pass filters BPF(A) to BPF(M) respectively have different frequency bands as pass bands. The band pass filters BPF(A) to BPF(M) respectively perform band-pass processing of respective shifter input signals corresponding to the respective pass bands, and respectively output the individual band-pass processed band signals to the phase shifters 81A to 81M.

The phase shifters 81A to 81M are arranged corresponding to the band pass filters BPF(A) to BPF(M), and each of the phase shifters has a structure similar to that of the phase shifter 1 described in the first embodiment. When inputting the individual band signals, the phase shifters 81A to 81M respectively perform phase adjustment operations on the basis of individual phase adjustment values θA to θM output from the phase control section 2′ and respectively output shifted individual band signals. Meanwhile, the individual phase adjustment values θA to θM are respectively set by each individual band by the phase control section 2′. Phase shift patterns which are similar to the pattern shown in FIG. 3(A) or 3(B) of the first embodiment are respectively set by each individual band in advance, and the individual phase adjustment values θA to θM are respectively changed based on the phase shift patterns.

The adder 82 adds the shifted individual band signals output from the phase shifters 81A to 81M together and outputs a shifter output signal of the frequency division type phase shifter 8.

Even with the above configuration, it is possible to suppress audio feedback from occurring similarly to the above first embodiment. In addition, the phase shift pattern can be adjusted by each individual band. Consequently, by providing, for example, a functional section for observing a growth of a level of a positive feedback signal by each band, it is possible to change the phase shift pattern of only a specific frequency band in response to the growth as a trigger.

Meanwhile, in each of the above embodiments, the method of changing the phase in the positive phase direction is exemplarily described. However, the phase can be changed in a negative phase direction (in a direction of orienting to 0 from 2π(0)).

In addition, in the pattern of repeating the time period of changing the phase and the time period of maintaining the phase constant, an example of giving a change in the phase of π/2 in the time period of changing one phase is described. However, it is possible to use another phase change amount such as, for example, a change in the phase of π/3.

Moreover, while in the above descriptions, an example of the loudspeaker having the audio feedback suppression device is shown, the above described audio feedback suppression device can be provided in a device of which the occurrence of audio feedback is not preferred, thereby achieving the above action and effect. This invention is based on Japanese Patent Application (JP-2008-159495) filed on Jun. 18, 2008, and the contents of which are incorporated herein by reference.

### INDUSTRIAL APPLICABILITY

In accordance with the invention, it is possible to, in relatively simple structure and process, generate an output audio signal having an amplitude equal to that of an input audio signal and a phase that varies, and to prevent audio feedback from occurring.

1. An audio feedback suppression device, comprising:
a first stage phase adjustment section that adjusts a phase of an input audio signal so as to output two first stage phase adjusted signals having phases which are shifted from each other by π/2 while synchronizing the two first stage phase adjusted signals with each other;
an adjusting phase value control section that outputs an adjusting phase while changing the adjusting phase with the lapse of time;
a second stage phase adjustment section that calculates a first multiplication coefficient which is one of a sine value and a cosine value of the adjusting phase and a second multiplication coefficient which is the other of the values, multiplies the first multiplication coefficient to one of the first stage phase adjusted signals to output a first multiplied signal, and multiplies the second multiplication coefficient to the other of the first stage phase adjusted signals to output a second multiplied signal; and
an output stage adder that adds the first multiplied signal and the second multiplied signal together to generate an output audio signal.

2. The audio feedback suppression device according to claim 1, wherein the first stage phase adjustment section includes a π/2 phase shift circuit and a delay circuit.

3. The audio feedback suppression device according to claim 1, wherein the adjusting phase value control section performs a phase control operation in such a manner that a time period of changing the adjusting phase with the lapse of time and a time period of not changing the adjusting phase are sequentially repeated.

4. An audio feedback suppression device comprising;
a plurality of phase adjustment sections each having the first stage phase adjustment section, the second stage phase adjustment section and the output stage adder according to claim 1;
a band division section that divides the input audio signal into different frequency bands and respectively outputs divided signals to the respective first stage phase adjustment sections of the plurality of phase adjustment sections; and
a composite output section that adds output audio signals of the respective phase adjustment sections together so as to generate a composite output signal.

5. A method for suppressing audio feedback comprising:
a process of adjusting a phase of an input audio signal and outputting two first stage phase adjusted signals having phases which are shifted from each other by π/2 while synchronizing the two first stage phase adjusted signals with each other;
a process of outputting a adjustment phase while changing the adjusting phase with the lapse of time;
a process of calculating a first multiplication coefficient which is one of a sine value and a cosine value of the adjusting phase and a second multiplication coefficient which is the other of the values, multiplying the first multiplication coefficient to one of the first stage phase adjusted signals to output a first multiplied signal and multiplying the second multiplication coefficient to the other of the first stage phase adjusted signals to output a second multiplied signal; and
a process of adding the first multiplied signal and the second multiplied signal together to generate an output audio signal.

6. The method for suppressing audio feedback according to claim 5, wherein in the adjusting phase, a time period of changing the adjusting phase with the lapse of time and a time period of not changing the adjusting phase are sequentially repeated.

7. A method for suppressing audio feedback, comprising:
a process of dividing an input audio signal into different frequency bands;
a process of adjusting the band-divided input audio signals in respective processes by adjusting a phase of an input audio signal and outputting two first stage phase adjusted signals having phases which are shifted from each other by π/2 while synchronizing the two first stage phase adjusted signals with each other, outputting a adjustment phase while changing the adjusting phase with the lapse of time, calculating a first multiplication coefficient which is one of a sine value and a cosine value of the adjusting phase and a second multiplication coefficient which is the other of the values, multiplying the first multiplication coefficient to one of the first stage phase adjusted signals to output a first multiplied signal and multiplying the second multiplication coefficient to the other of the first stage phase adjusted signals to output a second multiplied signal, and adding the first multiplied signal and the second multiplied signal together to generate an output audio signal to generate a plurality of output audio signals; and
a process of adding the output audio signals together to generate a composite output signal.

8. The audio feedback suppression device according to claim 2, wherein the adjusting phase value control section performs a phase control operation in such a manner that a time period of changing the adjusting phase with the lapse of time and a time period of not changing the adjusting phase are sequentially repeated.

9. An audio feedback suppression device comprising;
a plurality of phase adjustment sections each having the first stage phase adjustment section, the second stage phase adjustment section and the output stage adder according to claim 2.

10. An audio feedback suppression device comprising;
a plurality of phase adjustment sections each having the first stage phase adjustment section, the second stage phase adjustment section and the output stage adder according to claim 3.

11. An audio feedback suppression device comprising;
a plurality of phase adjustment sections each having the first stage phase adjustment section, the second stage phase adjustment section and the output stage adder according to claim 8.
